(19) United States
(12) Patent Application Publication
(10) Pub. No.: US 2002/0161636 A1
(43) Pub. Date: Oct. 31, 2002

(54) Information providing system

(75) Inventors: Yuko Takahashi, Yokahama (JP); Mitsuyoshi Tadokoro, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/002,515

(22) Filed: Oct. 31, 2001

(30) Foreign Application Priority Data
Apr. 26, 2001 (JP) 2001-128606

(51) Int. Cl. G06F 17/60

(52) U.S. Cl. 705/14; 705/10

(57) ABSTRACT

An information providing system includes a client that obtains user information and sends the information to a server; and the server that manages the user information sent from the client for each user and, based on the user information, selects information to be sent to the client. The client performs a pseudo conversation with a user to obtain a user's taste as the user information.

### BACKGROUND OF THE INVENTION

1. Field of the Invention

The present invention relates to a server/client system that provides information or services over a network.

2. Description of the Related Art

In a system that provides information services over a communication network, a client receives information from a server and displays the information on the client display. When a user finds an advertisement that interests him or her in the displayed information, the user requests the server to display detailed information on the advertisement for browsing.

An earlier patent disclosure dealing with an advertisement providing system is found in JP-A-2001-5871. This system provides the users all over the country with the advertisements of the same contents.

Service providers provide their customers with shopping points according to the amount of purchased goods or distribute coupons for sales promotion. There is also a need for shopping point or coupon distribution on a network.

### SUMMARY OF THE INVENTION

It is an object of the present invention to provide a system that offers information and services best suited to the user's status or taste.

It is another object of the present invention to provide a system capable of distributing shopping points or coupons over a network.

To achieve these objects, an information providing system comprises a client that obtains user information and sends the information to a server; and the server that manages the user information sent from the client on a user basis and, based on the user information, selects information to be sent to the client. The client performs a pseudo conversation with a user to obtain a user's taste as the user information.

The service server prepares coupons in a form of digital data, registers the coupons and the total member of issued coupons with a management server. The service server sends the coupons to a client over a network, and the management server manages the client to which the coupons are sent and the number of coupons.

The above and other objects, features and attendant advantages of the present invention will more easily be understood by reading the following description of the preferred embodiments thereof taken, only by way of example, in conjunction with the accompanying drawings.

### BRIEF DESCRIPTION OF THE DRAWINGS

FIG. 1 is a configuration diagram showing the whole system.

FIG. 2 is a system configuration diagram showing a part where advertisements are output.

FIG. 3 is a system configuration diagram showing a part where a character action instruction is output.

FIG. 4 is a system configuration diagram showing a part where a character is changed from one character to another.

FIG. 5 is a system configuration diagram showing a part where an item is distributed and traced.

FIG. 6 is a diagram showing the images of a character and an item on a PDA (Personal Digital Assistant).

FIG. 7 is a diagram showing advertisement extraction processing and advertisement output instruction reception processing.

FIG. 8 is a diagram showing advertisement output processing.

FIG. 9 is a diagram showing advertisement history transmission processing and advertisement history reception processing.

FIG. 10 is a diagram showing action extraction processing and action instruction reception processing.

FIG. 11 is a diagram showing character action execution.

FIG. 12 is a diagram showing event recording processing.

FIG. 13 is a diagram showing action history transmission processing and action history reception processing.

FIG. 14 is a diagram showing character transmission processing and character reception processing.

FIG. 15 is a diagram showing item registration processing.

FIG. 16 is a diagram showing item distribution permission processing and distribution permission reception processing.

FIG. 17 is a diagram showing item distribution processing and item reception processing.

FIG. 18 is a diagram showing distribution history transmission processing and distribution history reception processing.

FIG. 19 is a diagram showing item tracing processing.

FIG. 20 is a diagram showing an example of an advertisement table 0203 and an advertisement output instruction table 0210.

FIG. 21 is a diagram showing an example of an advertisement history master table 0204 and an advertisement history table (local) 0211.

FIG. 22 is a diagram showing an example of a user table 0205.

FIG. 23 is a diagram showing an example of a taste table 0206.

FIG. 24 is a diagram showing an example of an action pattern file 0303 and a character action instruction table 0309.

FIG. 25 is a diagram showing an example of an action history master table 0304 and an action history table (local) 0310.

FIG. 26 is a diagram showing an example of a character table 0402 and a character table (local) 0404.

FIG. 27 is a diagram showing an example of an item issuance table 0505.

FIG. 28 is a diagram showing an example of an item distribution history master table 0506 and an item distribution history table (local) 0512.

FIG. 29 is a diagram showing an example of an item management table 0507.

FIG. 30 is a diagram showing an example of an item table 0511 and an item table (local) 0514.

### DESCRIPTION OF THE EMBODIMENTS

Now, the present invention will be described in detail in conjunction with what is presently considered as preferred or typical embodiments thereof by reference to the drawings. In the following description, like reference characters designate like or corresponding parts throughout the several views.

1. System Configuration

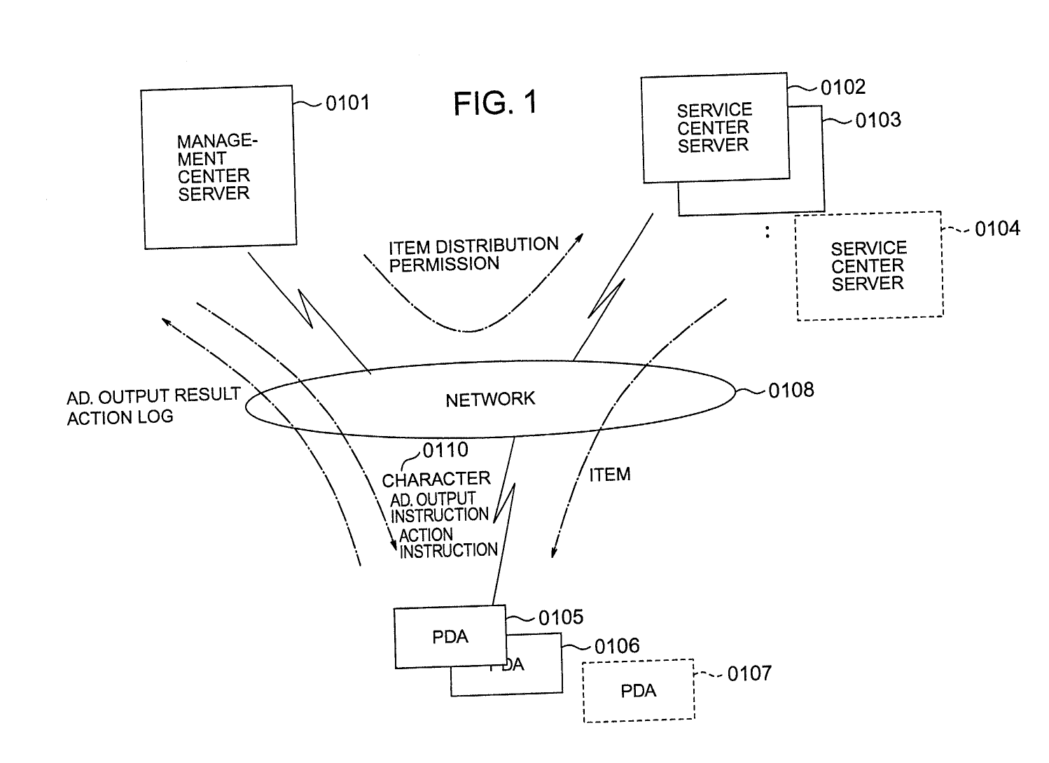

FIG. 1 shows the general view of a system. In FIG. 1, numeral 0101 is a server that manages the whole system; numerals 0102-0104 are servers that provide various services; numerals 0105-0107 are a plurality of clients; and numeral 0108 is a network.

The clients 0105-0107 are connected to the network via cable or radio waves. A client, such as a personal computer, a PDA (Personal Digital Assistant, mobil terminal), and a cellular phone, can download software programs, such as JAVA-coded programs, for execution. In the description of this embodiment, a client is assumed to be a PDA.

There may be a plurality of management center servers 0101, and there may be only one service center server. The management center server may function also as a service center server.

2. Character

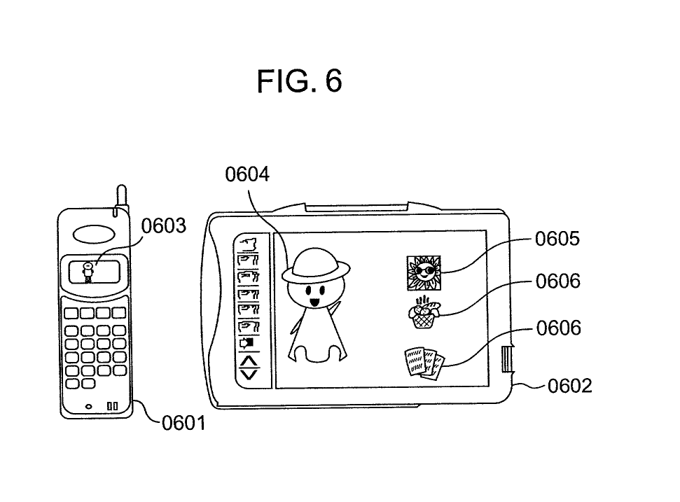

The management center server supplies a software program with an agent function. This program is called a character. There are a plurality of characters each being adapted for special use (character attribute). Each character has a function such as a restaurant guidance or schedule management. A character, once downloaded onto a PDA, displays an animation, such as the one indicated by 0603 or 0604 in FIG. 6, on the display screen of the PDA. An animation, which varies according to the character attribute, is a human being or an animal. Music may be played back with the display of an animation. A character displays questions and options on the screen for executing a pseudo conversation. For example, questions are “Are you hungry?” or “Do you like Chinese food?”, and options are “Yes”, “No”, or “a little”. When the user selects an option via an input device of a PDA, the animation (for example, a rabbit) changes in expression or posture according to the selected option. In addition, a character changes display information according to a selected option. As the user selects an option, the character prepares the next question according to the selected option, saves the user selection on a storage unit, and sends the selection to the management center server. Also, a character displays information sent from the server.

3. Item

A service server supplies a software program called an item. There are several types of items each equivalent to a coupon or a premium ticket. An item, once sent to a PDA, displays images such as those indicated by 0605-0607 in FIG. 6 on the display screen of the PDA. An image, which depends on the type of item, is a supermarket logo or a premium image. When the user selects one of these images, a large bar code representing the contents of, or information on, the item is displayed on the display screen. This bar code may be read externally by a scanner. Instead of displaying a bar code, a Bluetooth-compatible radio signal representing the contents of, or information on, the item may be output.

4. Advertisement Output

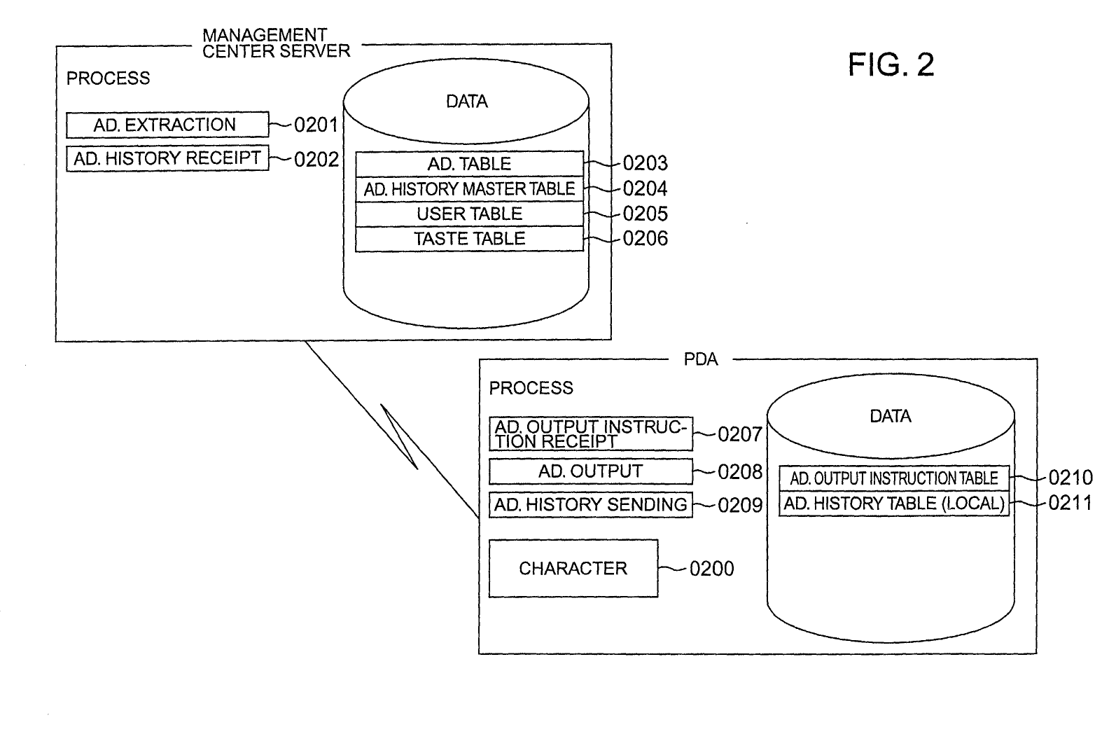

A character on a PDA receives an advertisement output instruction from the management center server and displays advertisements on the display screen. FIG. 2 shows processing related to advertisement output and the configuration of the tables stored in the management center server and a PDA.

In FIG. 2, numeral 0203 is an advertisement table describing an advertisement to be output on a PDA by a character 0200 and an advertisement output generation conditions; numeral 0204 is an advertisement history master table in which data from advertisement history tables (local) 0211 on PDAs is collected; numeral 0205 is a user table; numeral 0206 is a taste table in which the taste and nature of PDA users are stored; numeral 0210 is advertisement output instruction table in which an advertisement and an advertisement output instruction extracted from the advertisement table 0203 are stored; and numeral 0211 is the advertisement history data table (local) in which the advertisements output on a PDA are recorded.

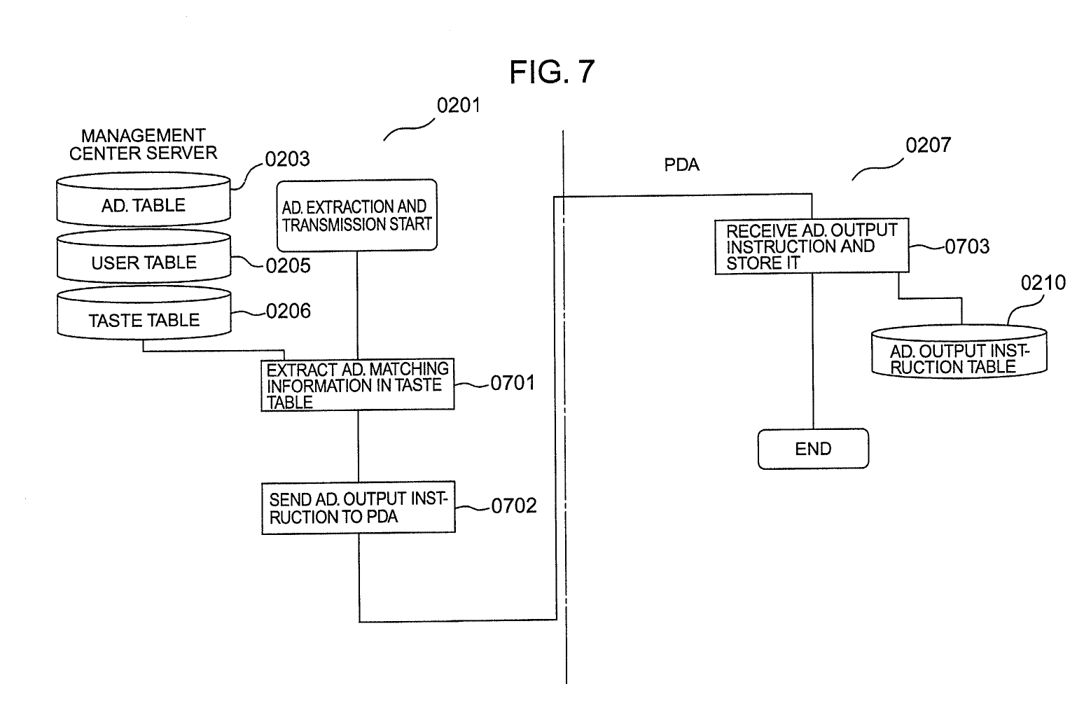

FIG. 7 is a flowchart showing how an advertisement is extracted for each user and how an extracted advertisement is transferred to a PDA. From the advertisement table 0203, the management center server extracts an advertisement to be output. At this time, the management center server uses the taste table 0206 as an extraction condition to find the taste of the user to which the advertisement is output. The management center server also uses information on the user's address, age, sex, and status stored in the user table 0205 as an extraction condition (step 0701). The management center server sends the extracted advertisement to a PDA as an advertisement output instruction (step 0702). Upon receiving the advertisement output instruction, the PDA stores it in the advertisement output instruction table 0210 (step 703).

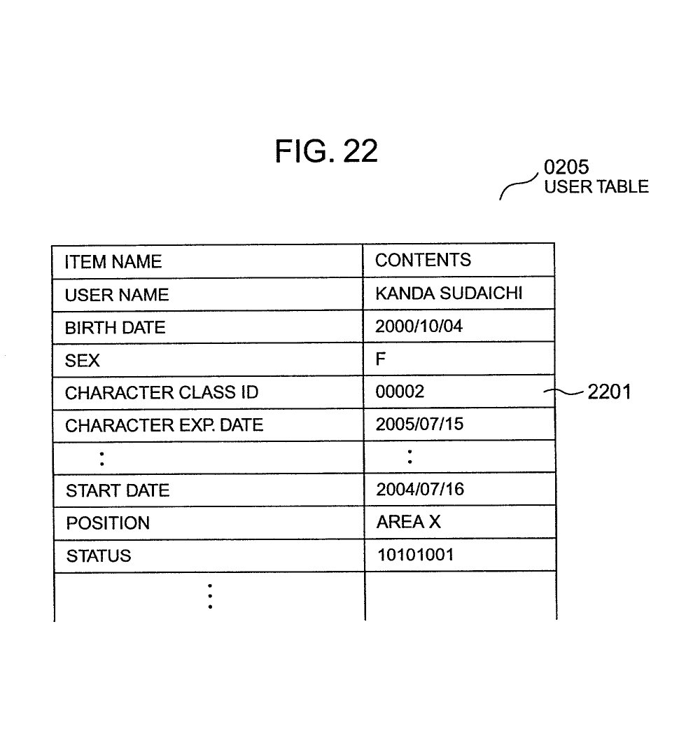

FIG. 22 shows an example of the user table 0205. The user table, prepared for each user, contains permanent information such as a user name, birth date, and sex and temporary information such as a character in use and the position. The management center server updates temporary information according to information sent from a PDA. The contents of a conversation between the above-described character and a user are sent from the PDA to the management center server and are stored in the “Status” item of the user table, for example, in the form of a flag. The “Status” item also contains information on whether or not the PDA is available for communication.

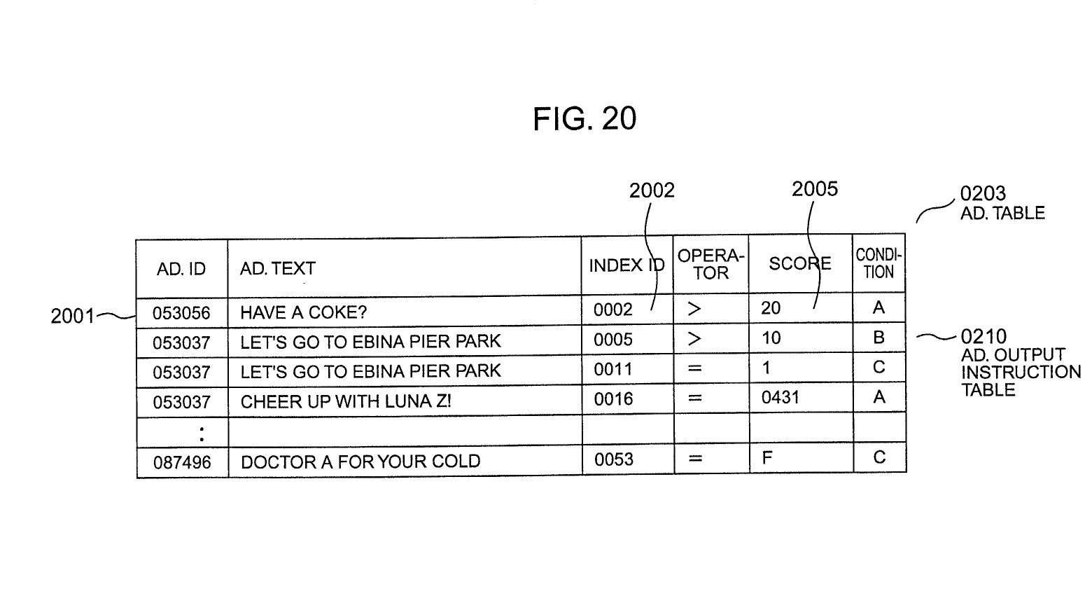

FIG. 20 shows an example of the advertisement table 0203. The management center server creates and updates the advertisement table 0203 in response to a request from an advertisement client. The advertisement output instruction table 0210 also has the format shown in FIG. 20.

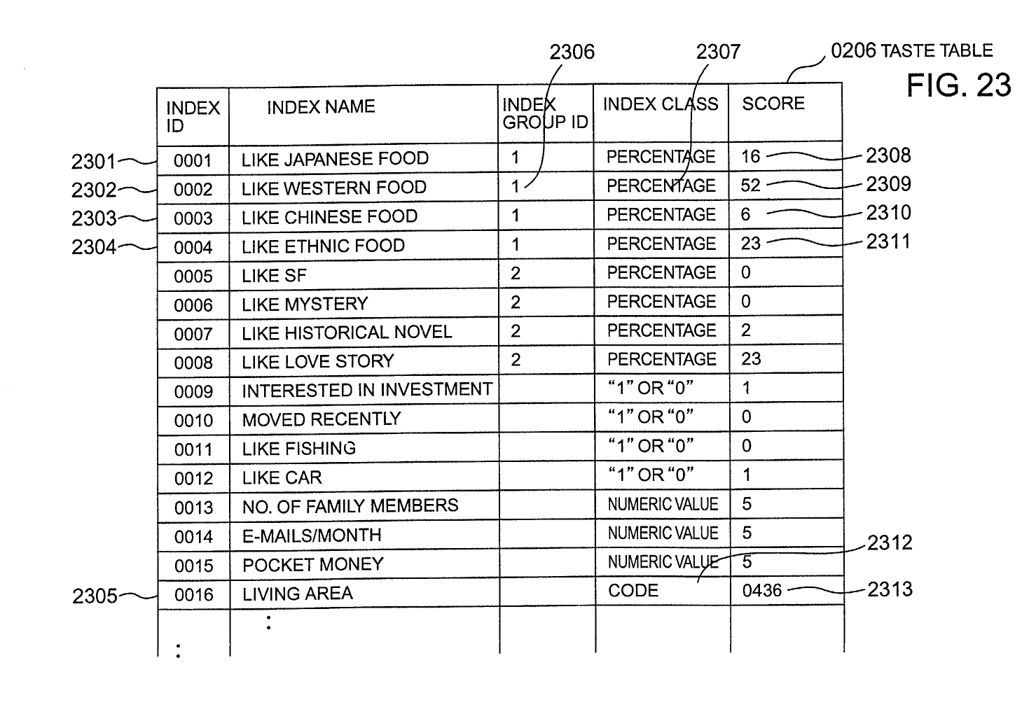

FIG. 23 shows an example of the taste table 0206. The taste table is prepared for each user and, as will be described later, the management center server updates the contents of the table according to information sent from a PDA.

Now, consider how an advertisement will be extracted from the advertisement table in FIG. 20 for transmission to a user whose taste is stored in the taste table in FIG. 23.

Row 2001 in FIG. 20 requires that the score 2005 of the index ID 2002 be larger than 20. On the other hand, row 2302 whose index ID is 0002 in FIG. 23 indicates that the score 2309 is 52. Because the index class column 2307 contains “percentage”, the percentage is calculated from the scores 2308-2311 in rows 2301-2304 that belong to the same index group “1” (2306). The calculation result is 52/(16+52+6+23)=53.6%. Because 53.6>20, the advertisement in row 2001 in FIG. 20, which satisfies the extraction condition, is sent to the PDA.

Advertisement extraction and transmission processing is performed regularly or at an event such as Christmas. This processing may also be done as the user performs some operation on a PDA. In addition, with a transmission-timing item provided for each record of the advertisement table 0203, only an advertisement satisfying the timing requirement may be extracted at advertisement extraction time.

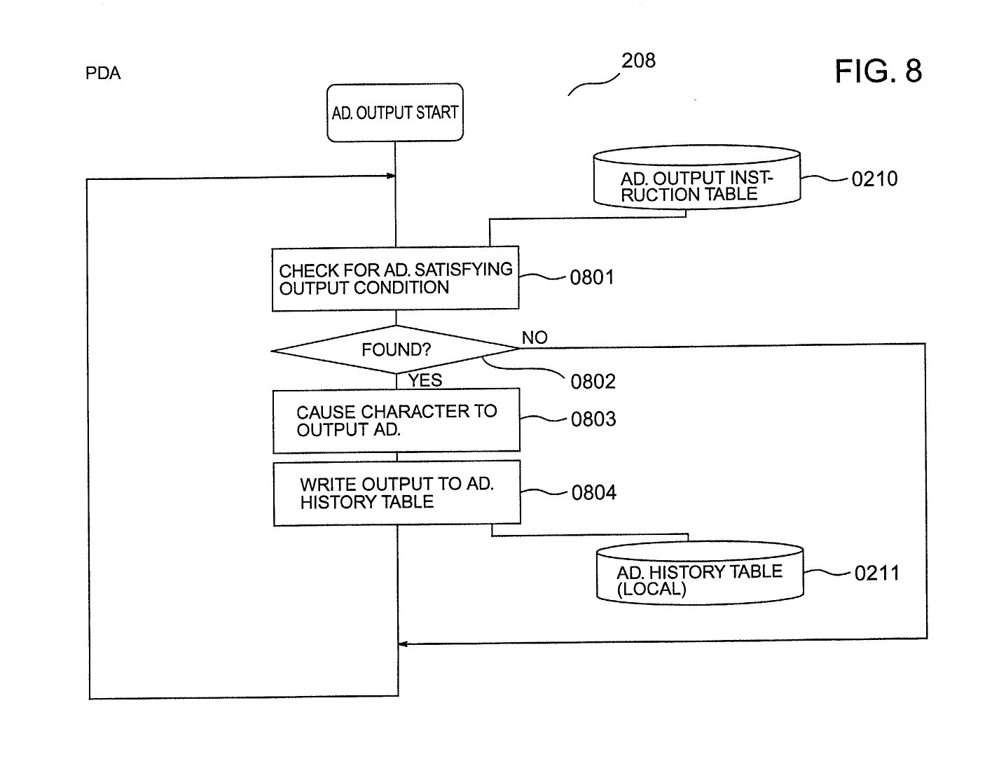

FIG. 8 is a flowchart showing how an advertisement is output on a PDA.

A Daemon program always runs in the background to execute this processing. The program compares an advertisement output condition stored in the advertisement output instruction table 0210 with the PDA operation status (step 0801). If an equal condition is found for the output condition, the program causes the character 0200 to output the corresponding advertisement contents (step 0803). After successful advertisement output, the program outputs the log to the advertisement history table (local) 0211 for use in later transfer of advertisement history data (step 0804).

An advertisement is displayed in a free area on the display screen of the PDA for a predetermined time.

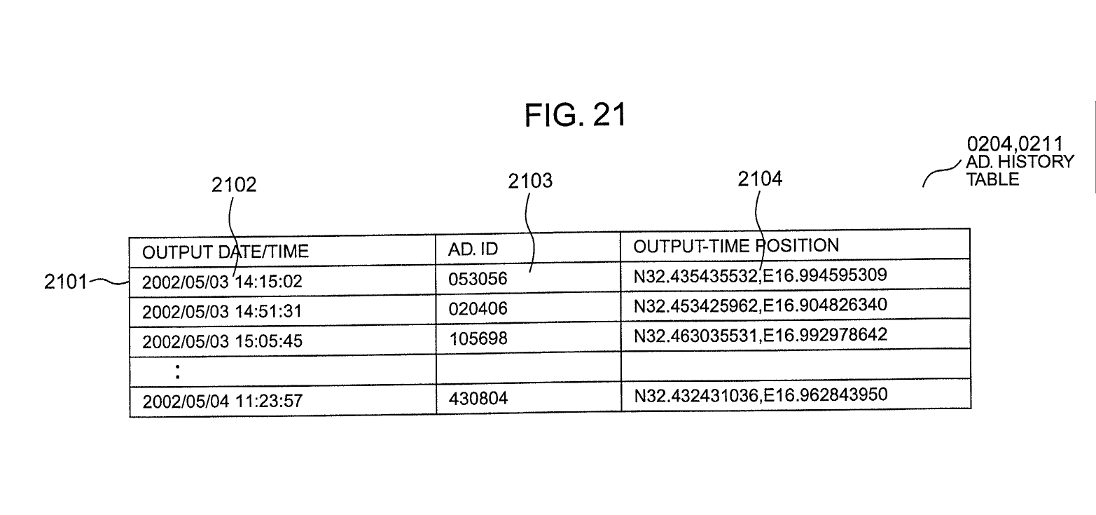

FIG. 21 shows an example of advertisement history table (local) 0211 of a PDA. For example, when the advertisement in the row 2001 in FIG. 20 is output by a character, a new row 2101 is added to FIG. 21 to store the following data: the date and time, at which the advertisement was output by the character, in a date and time field 2102; the advertisement ID 2002 of FIG. 20 in an advertisement ID field 2103; and the PDA coordinates, where the advertisement was output by the character, in an output time position field 2104.

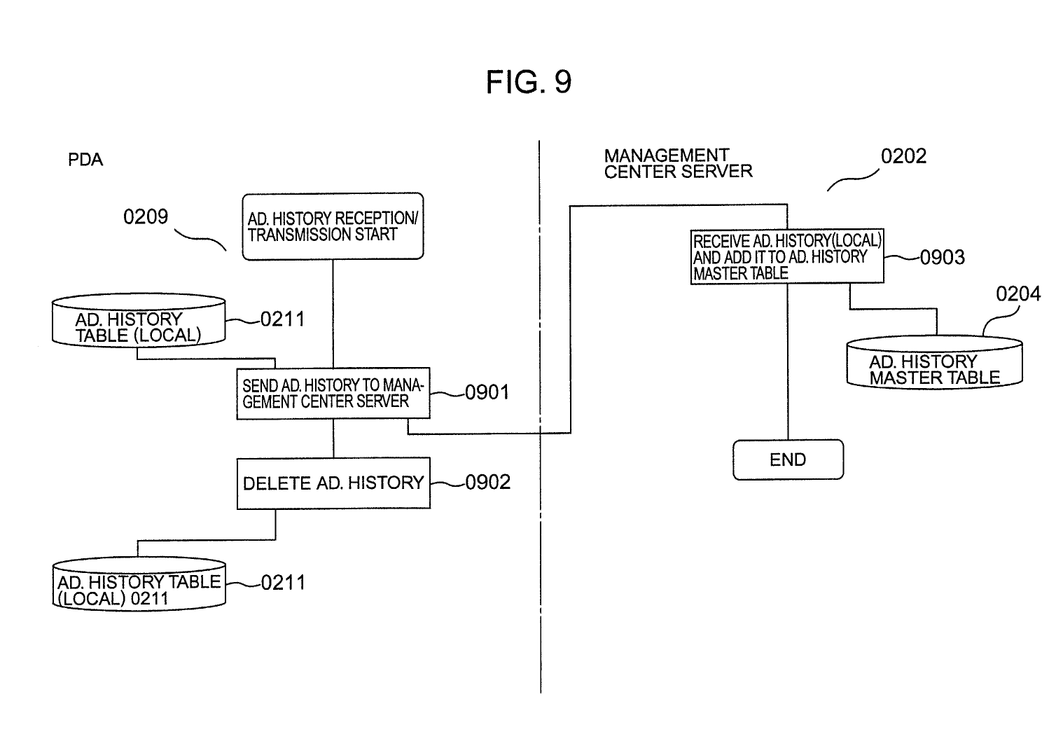

FIG. 9 shows how a PDA transmits data from the advertisement history table (local) 0211 to the management center server. This processing is performed when the history table (local) has reached a predetermined size or when the PDA is connected to the network.

A PDA transmits data, accumulated in the advertisement history table (local) 0211, to the management center server (steps 0901 and 0903). After successful transmission, the PDA deletes the transmitted data from the advertisement history table (local) 0211 (step 0902). The management center server has the advertisement history master table 0204 for each of all users. The management center server adds the received advertisement history data to the advertisement history master table 0204 (step 0903).

5. Character Action Instruction

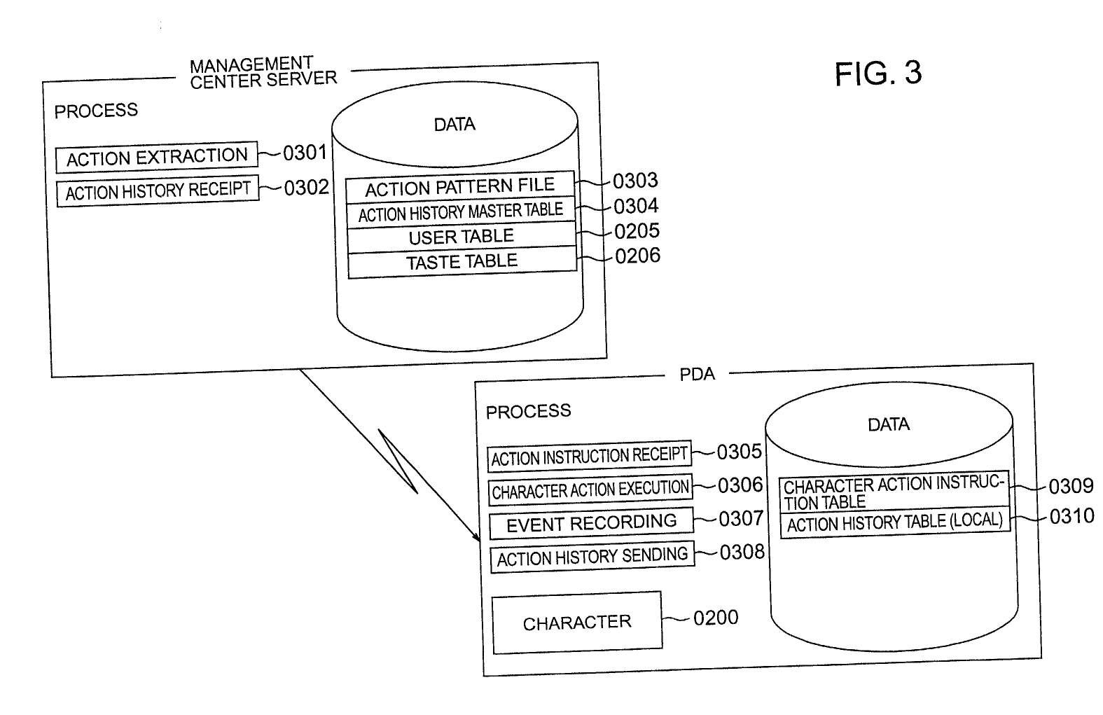

In response to a character action instruction from the management center server, the character on a PDA performs processing according to the instruction. For example, the character emits a sound to inform the user of a schedule or takes a nap. FIG. 3 shows character action processing, performed by the management center server and a PDA, and the configuration of the tables used for the processing.

In FIG. 3, numeral 0303 is an action pattern file that describes character actions on a PDA and action generation conditions; numeral 0304 is an action history master table in which data from the local action history table 0310 of a character on each PDA is collected; numeral 0309 is an action instruction table created by extracting character actions and action generation conditions from action pattern file 0303; and numeral 0310 is the action history data table in which information on character actions on a PDA and the record of user's PDA operation are retained locally on the PDA. The user table 0205 and the taste table 0206 are the same as those in FIG. 2.

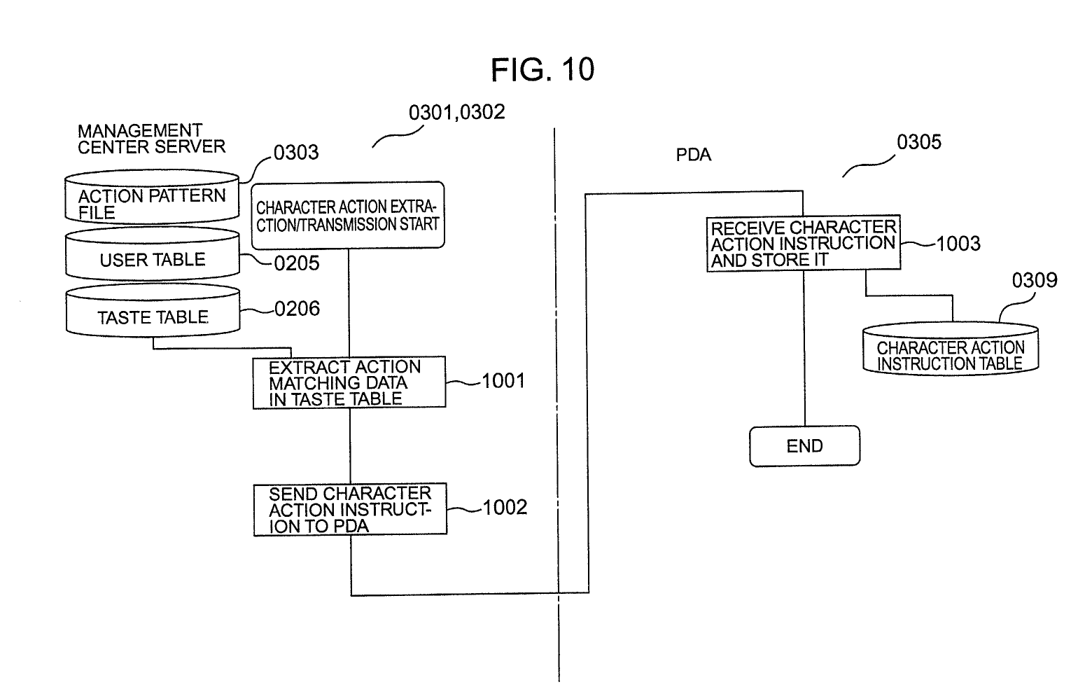

FIG. 10 is a flowchart showing how a character action instruction is extracted for each user and how it is transferred to a PDA.

The management center server extracts a character action instruction from the action pattern file 0303 and sends it to the PDA. At this time, as when sending an advertisement, the management center server uses the taste table 0206 and the user table 0205 for the extraction (step 1001). The management center server sends the extracted character action instruction to the PDA, and the PDA stores it in the table 0310 (steps 1002 and 1003).

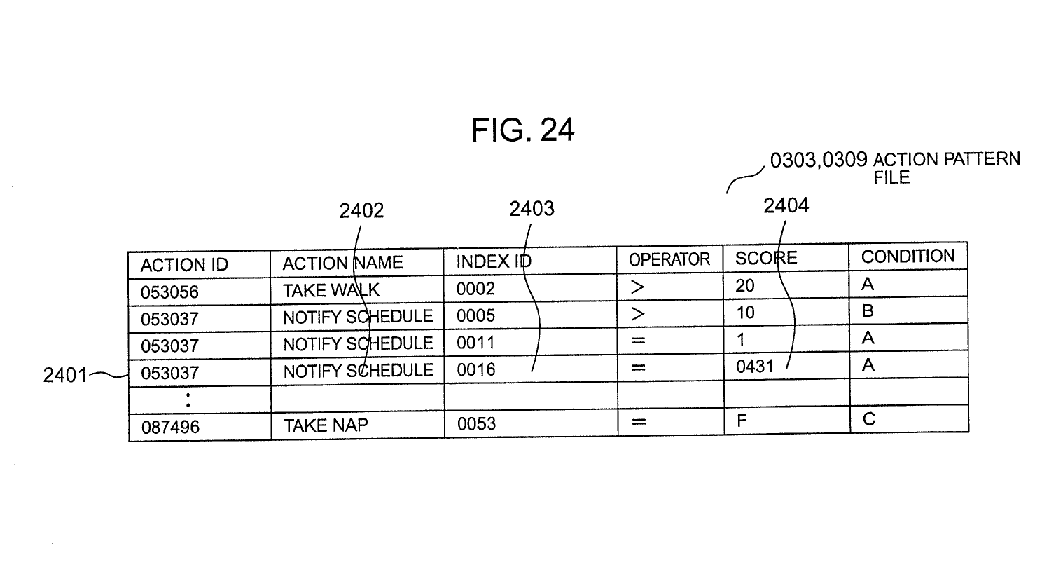

FIG. 24 shows an example of the action pattern file 0303. Consider how the management center server extracts an action from the action pattern file in FIG. 24 and sends a character action instruction to the PDA of a user whose taste table is shown in FIG. 23. Row 2401 in FIG. 24 requires that the score 2404 of the index ID 0016 be 0431. On the other hand, in FIG. 23, checking row 2305 whose index ID field contains 0016 indicates that the score field 2313 contains 0436. Because the index class field 2312 contains “Code” and 0431≠0436, row 2401 in FIG. 24 does not satisfy the extraction condition and therefore the instruction is not sent to the PDA.

This processing may be performed weekly, monthly, at any event such as Christmas, or at an interval of any combination of them. Either the user of the PDA or the management center server may start the transmission of an instruction.

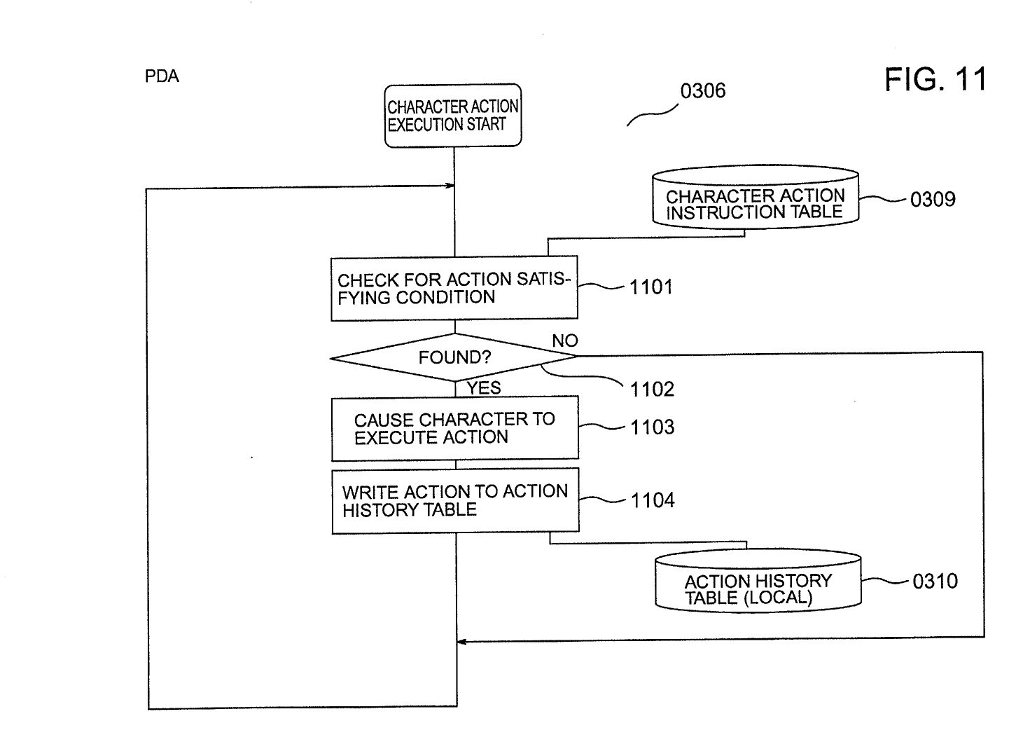

FIG. 11 is a flowchart showing how a character action is executed on a PDA. A Daemon program always runs in the background to execute this processing. The program compares the conditions in the action instruction table 0309 with the operation status of the PDA (step 1101). If an equal condition is found, the program causes the character 0200 to execute the corresponding action (step 1103). After successful action execution, the program outputs the log to the action history table (local) 0310 for use in later transfer of action history data (step 1104).

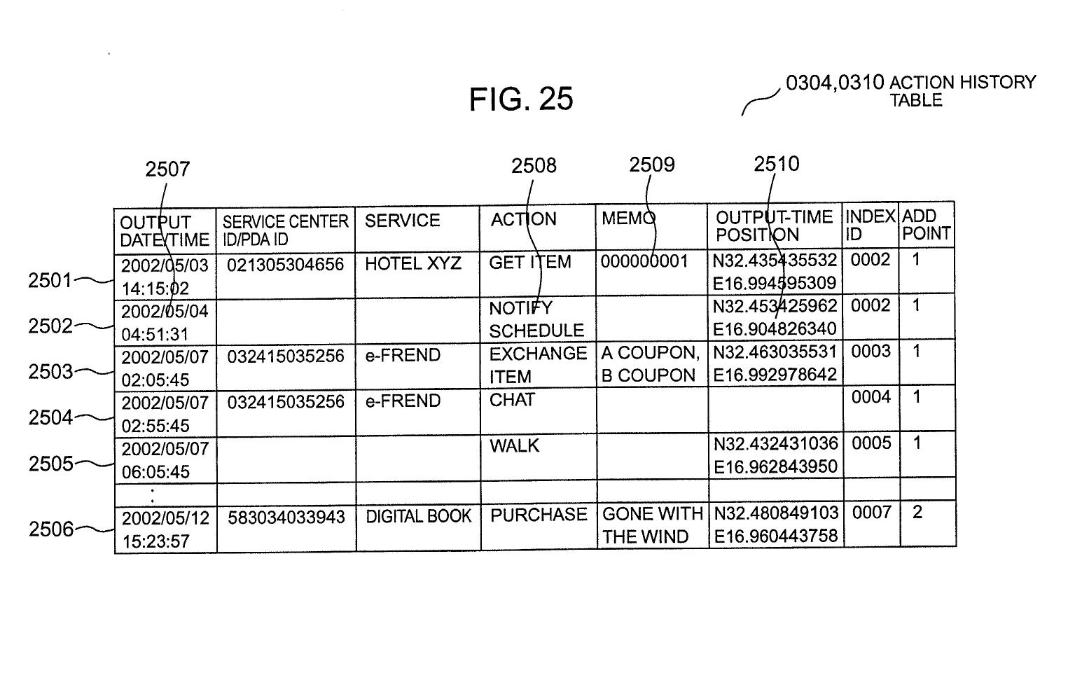

FIG. 25 shows an example of an action history table (local) 0310. Suppose that the character is to execute row 2401 in FIG. 24. The program calls the character schedule notification routine and then adds a new row 2502. The date and time at which the schedule notification routine was started is set in the output date/time field 2507, the action name 2402 in FIG. 24 is set in the action field 2508, and the coordinates on the display screen at which the notification was displayed is set in the output-time position field 2510.

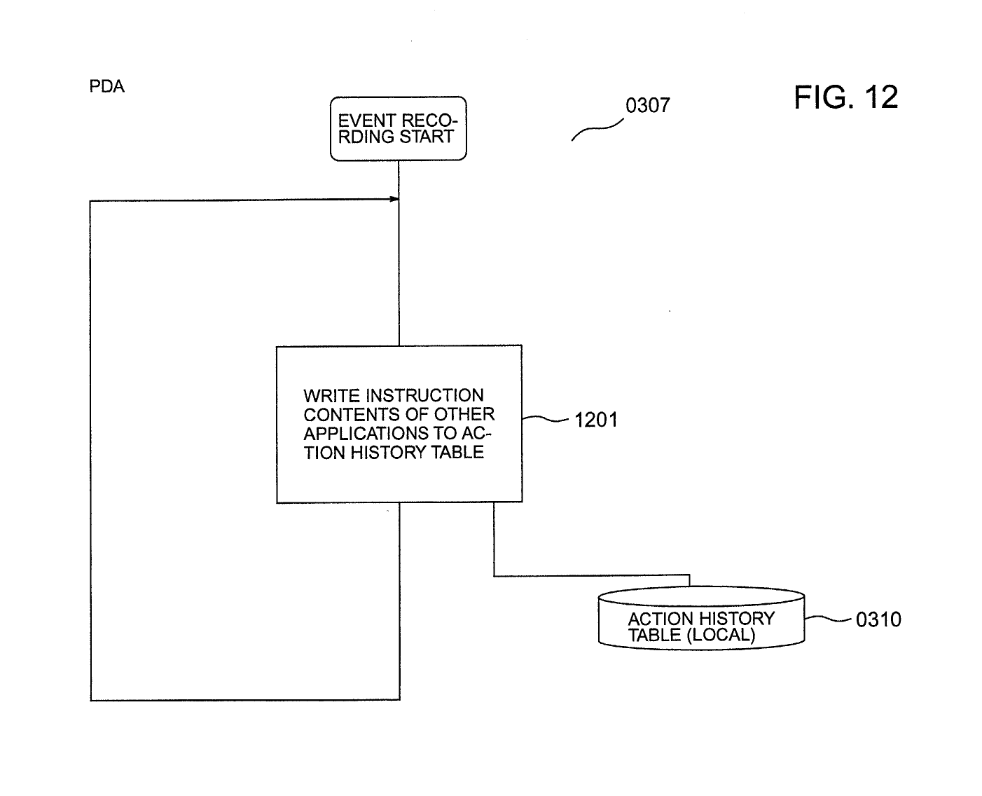

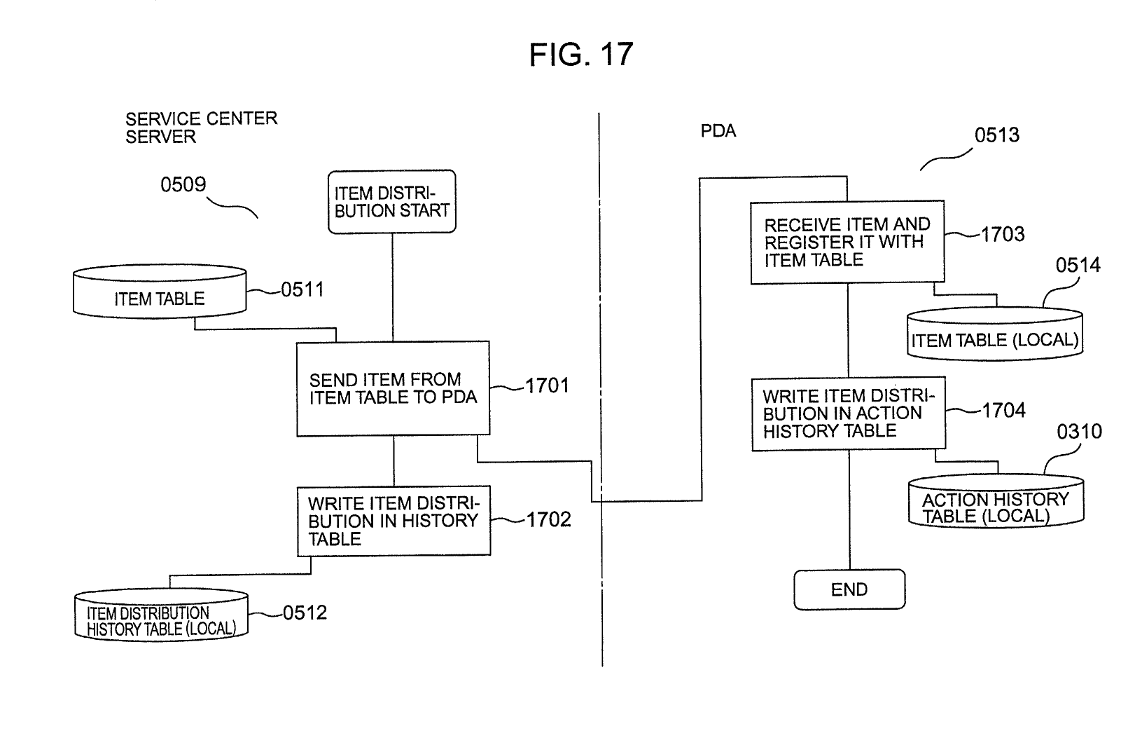

FIG. 12 shows how information on user operation on a PDA is written to the action history table (local) 0310 as an event. Although character action and item acquisition are recorded in the action history table (local) 0310 in FIG. 11 and FIG. 17, information on user's operation on a PDA is also written to the action history table (local) 0310 in this processing.

For example, a mailer calls this processing routine when sending or receiving mail to output log data to the action history table (local) 0310. Applications such as a scheduler or a game program also calls this processing routine to write data to the log.

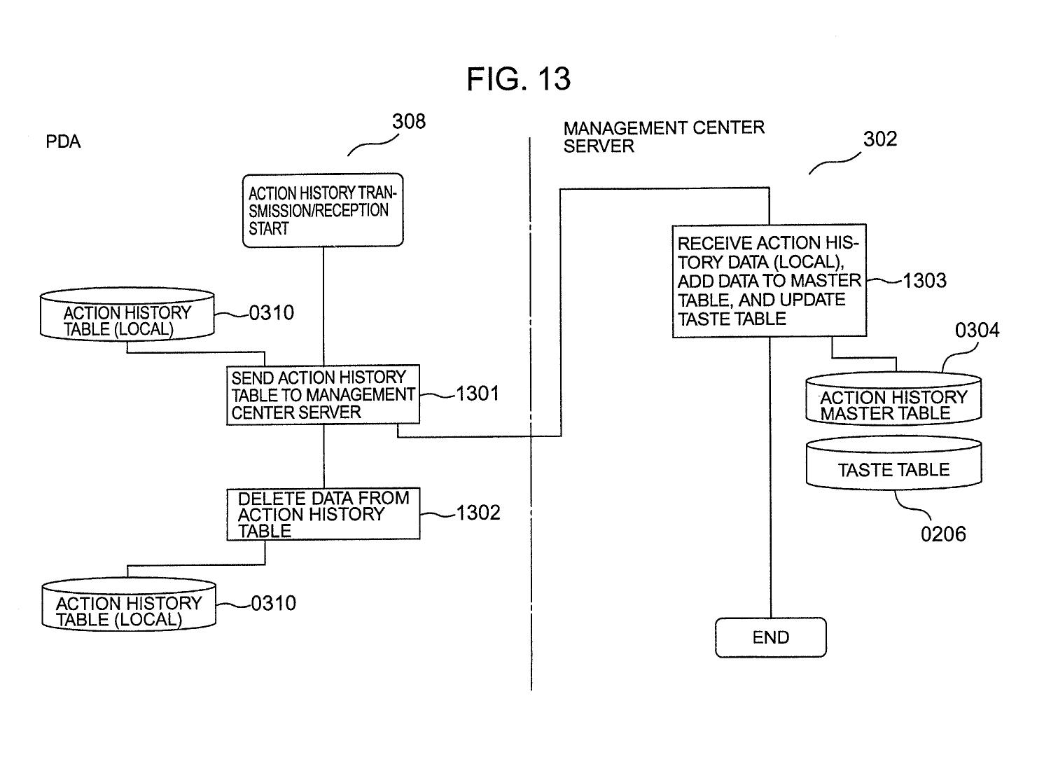

FIG. 13 shows how a PDA transmits data, accumulated in the action history table (local) 0310, to the management center server. A PDA transmits data, accumulated in the action history table (local) 0310, to the management center server (steps 1301 and 1303). This processing is performed when the action history table (local) reaches a predetermined size or when the PDA is connected to the network. After successful transmission, the PDA deletes the transmitted data from the action history table (local) 0310 (step 1302). The management center server uses data, received from action history table (local) 0310, to update the taste table 0206 and adds the received action history data to the action history master table 0304 (step 1303).

6. Character Change

The management center server supplies a plurality of characters to allow a PDA to download a character according to the purpose. When outputting an advertisement or a character action instruction, the management center server and a PDA perform the same processing for all characters. Therefore, the same taste table 0206 and the same user table 0205 are used on the management center server even when the character changes from one character to another.

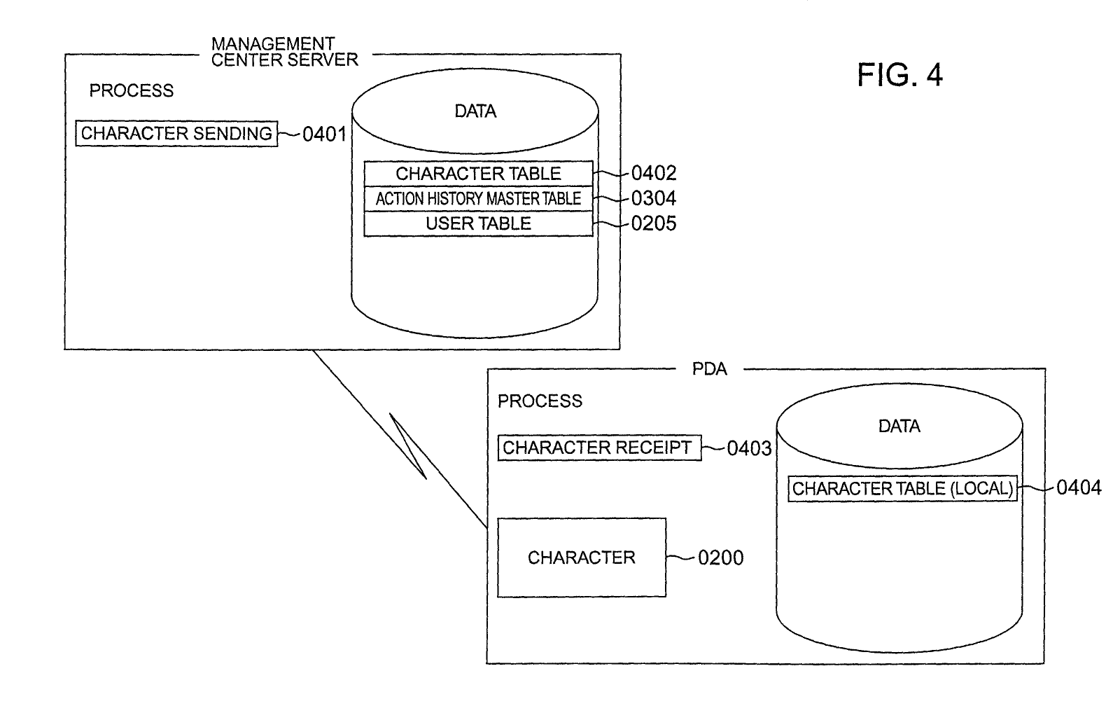

In FIG. 4, numeral 0402 is a character table in which character attributes, including character action programs, are stored. Numeral 0404 is a subset of the character table 0402 used by a PDA.

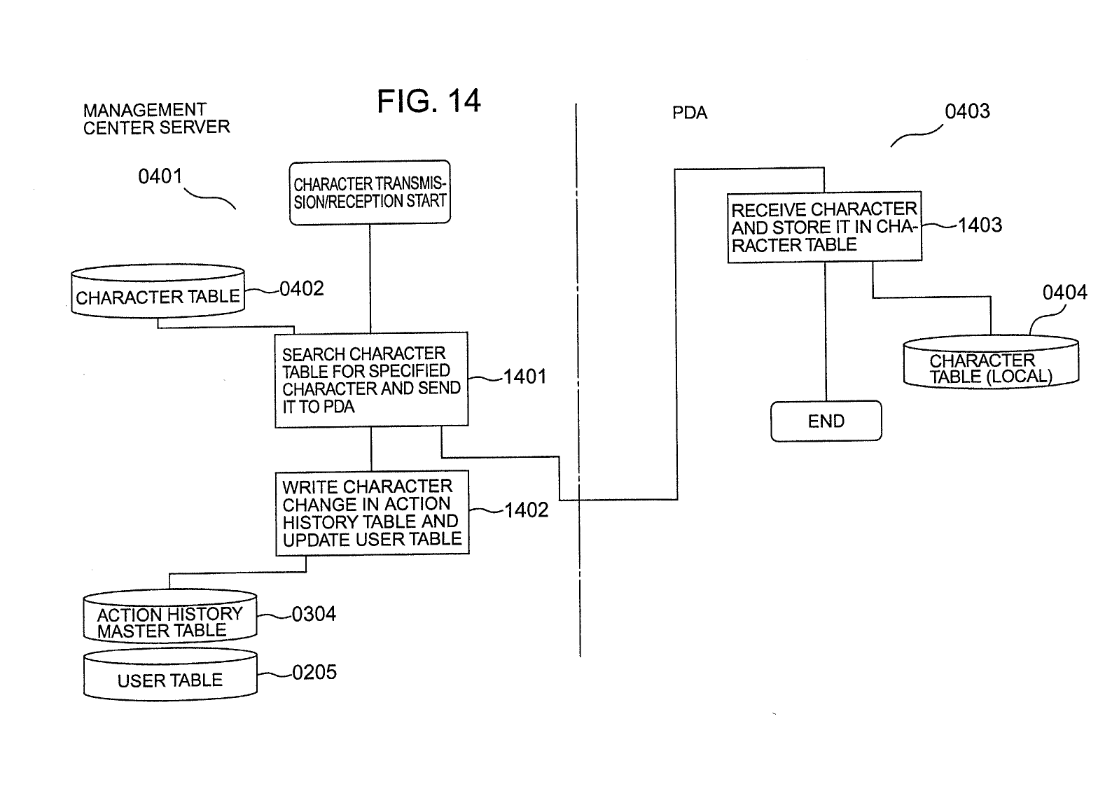

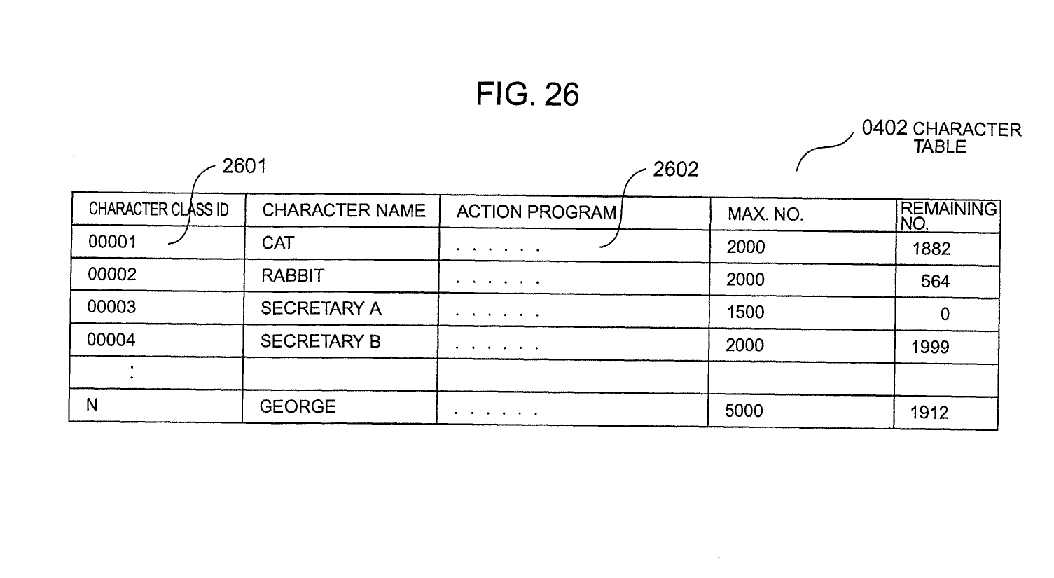

FIG. 14 shows how a character on a PDA is changed from one character to another. The management center transmits to the PDA the character attribute action program of the specified character stored in the character table 0402 (steps 1401 and 1403). The transmitted program operates as the character 0200. The management center server adds the log to the action history master table 0304 to indicate that the character has been changed and then writes a user's new character in the user table 0205 (step 1402). FIG. 26 shows an example of the character table 0402. A character action program 2602, which depends upon the character, executes actions such as “take a walk”, “take a nap”, and “do default action”. A character class ID 2601 in FIG. 26 is written in a character class ID 2201 of the user table 0205.

To limit the number of times a character is to be distributed, the management center server may have the Max. No. column and the Remaining No. column added to the character table 0402 to allow the management center server to update these columns when the character is distributed.

7. Item Distribution

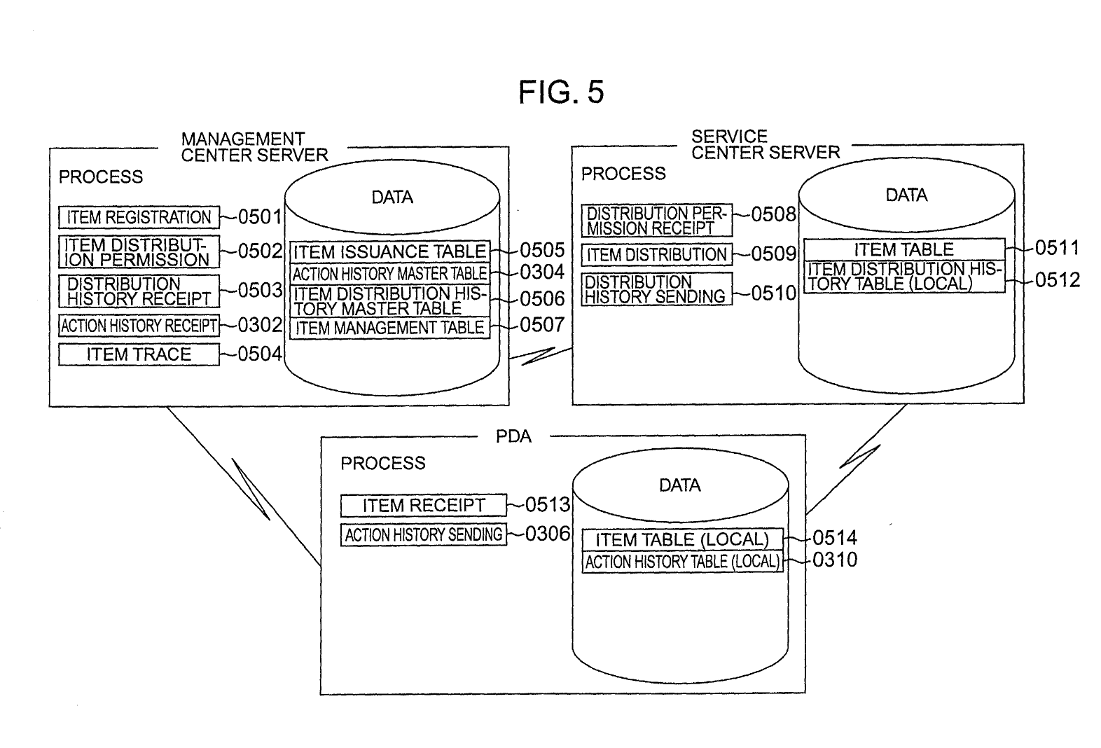

With the permission of the management center server, a service center server creates an item for distribution to PDAs. FIG. 5 shows item distribution processing and the configuration of the tables for use in item distribution.

In FIG. 5, numeral 0505 is an item issuance table in which item IDs available to service center servers and the maximum issuance numbers are stored; numeral 0506 is an item distribution history master table in which data from an item distribution history table 0512 of the service center servers is collected; numeral 0507 is an item management table in which the holder of each item serial No. is recorded; numeral 0511 is an item table in which the attributes of items, including an item display program and an execution program, are stored; numeral 0512 is an item distribution history table in which information on item distribution from a service center server to PDAs is stored; and numeral 0514 is an item table in which information on items displayed on a PDA is stored.

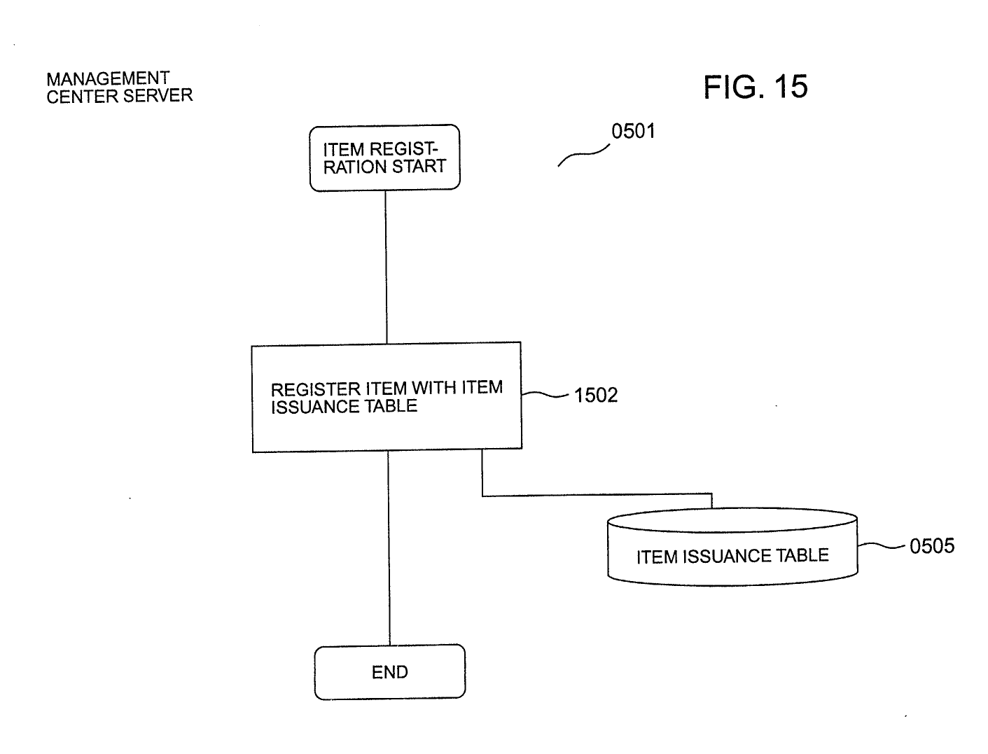

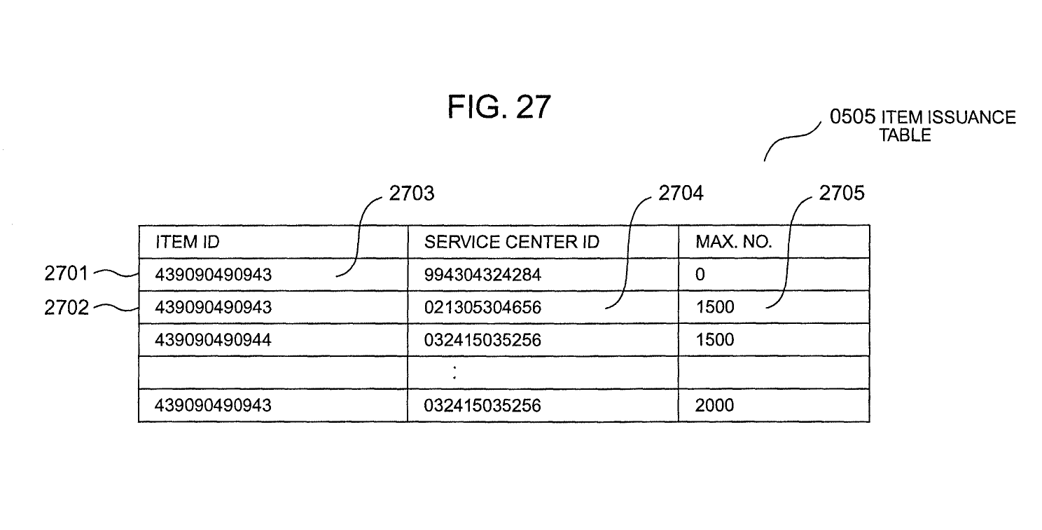

FIG. 15 is a flowchart showing how the management center server registers items with the system. In response to a request from a service center server, the management center server assigns an ID to an item and registers it with the item issuance table 0505 (step 1502). FIG. 27 shows an example of the item issuance table 0505. In the processing shown in the flowchart, a row is added to this table with an item ID 2703 assigned to the added item.

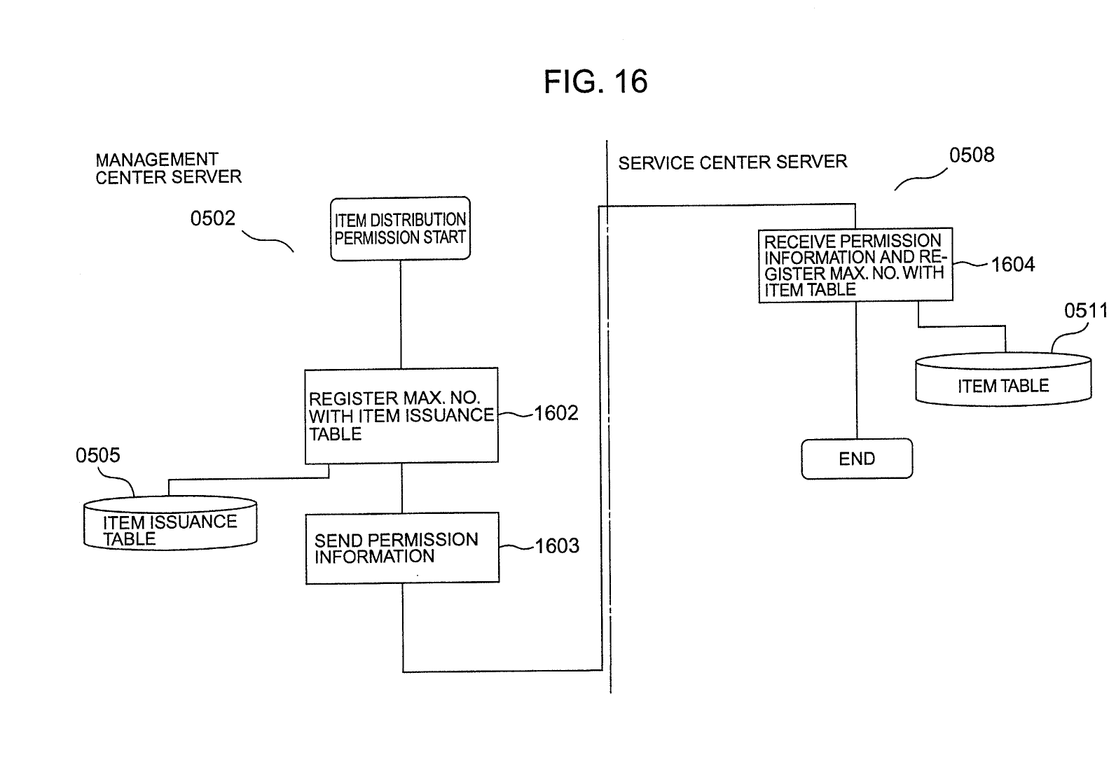

FIG. 16 shows how the management center server permits a service center server to distribute items. The management center server accepts the maximum number of times a service center server is able to distribute an item and records that number in the item issuance table (step 1602). Next, the management center server sends the item ID and the maximum number to the service center server. Upon receiving, the service center server writes them in the item table 0511 (steps 1603 and 1604). In the example shown in FIG. 27, to permit service center 021305304656 to distribute an item with the item ID 439090490943 up to 1500 times, the management center server adds row 2702 to the item issuance table 0505 to set the service center ID 2704 and the maximum number 2705.

FIG. 17 shows how a PDA obtains an item from a service center server. Selecting an advertisement or information displayed on a PDA allows the PDA to connect to the service center server to receive an item or other services.

The service center server sends an item attribute program from the item table 0511 to the PDA. Upon receiving, the PDA stores the item attribute program in the item table (local) 0514 (steps 1701 and 1703). The item attribute program includes an item display program. If the PDA already has the same item, the service center server sends only information on the maximum number and the remaining number. After successful item transmission, the service center server writes a row to the item distribution history table (local) 0512 to indicate that it has distributed the item. On the other hand, the PDA records a row in the action history table (local) 0310 to indicate that it has obtained the item.

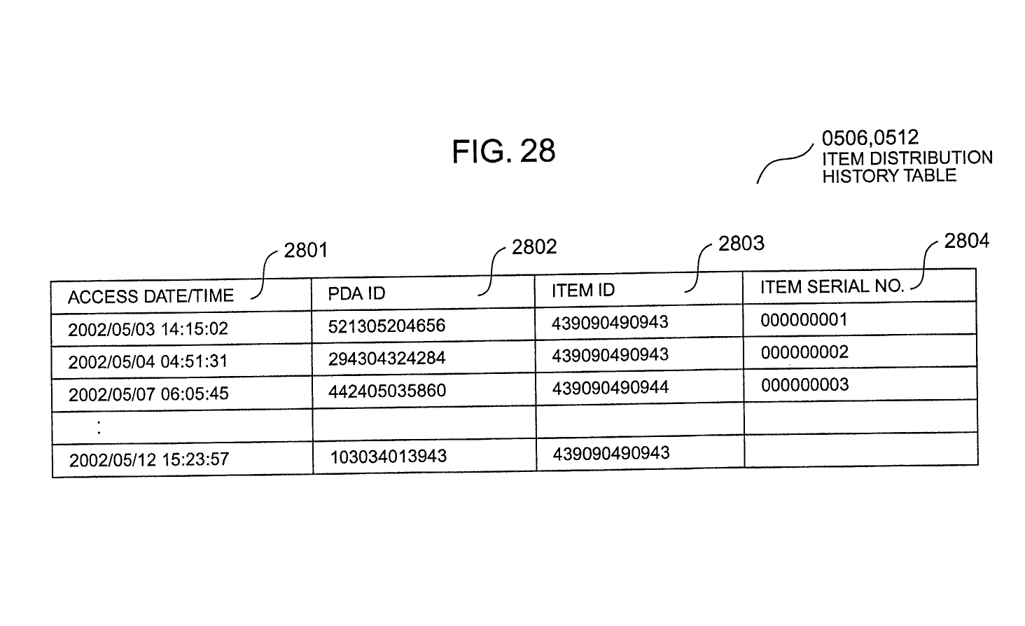

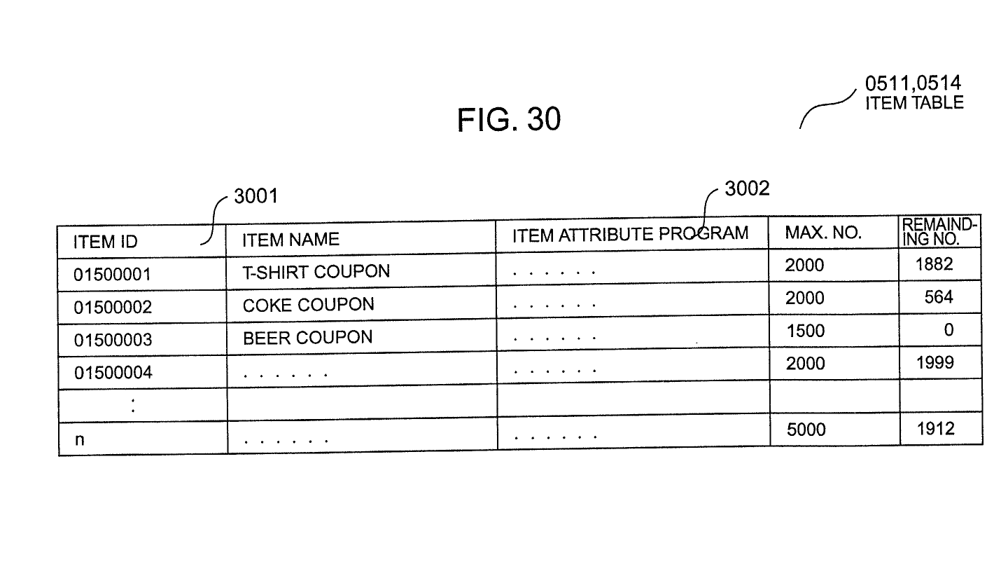

FIG. 30 shows an example of the item table (local) 0514. Programs stored in the Program column 3002, each prepared for an item, have the same application interface. FIG. 28 shows an example of the item distribution history table (local) 0512. The Access Date column 2801 contains a date/time at which an item was acquired, the PDA ID column 2802 contains a PDA ID, the Item ID column 2803 contains an item ID 3001 stored in the item table in FIG. 30, and the Item Serial No. column 2804 contains a serial number assigned to a distributed item. Row 2501 in FIG. 25 is an example of a row added to the action history table 0310.

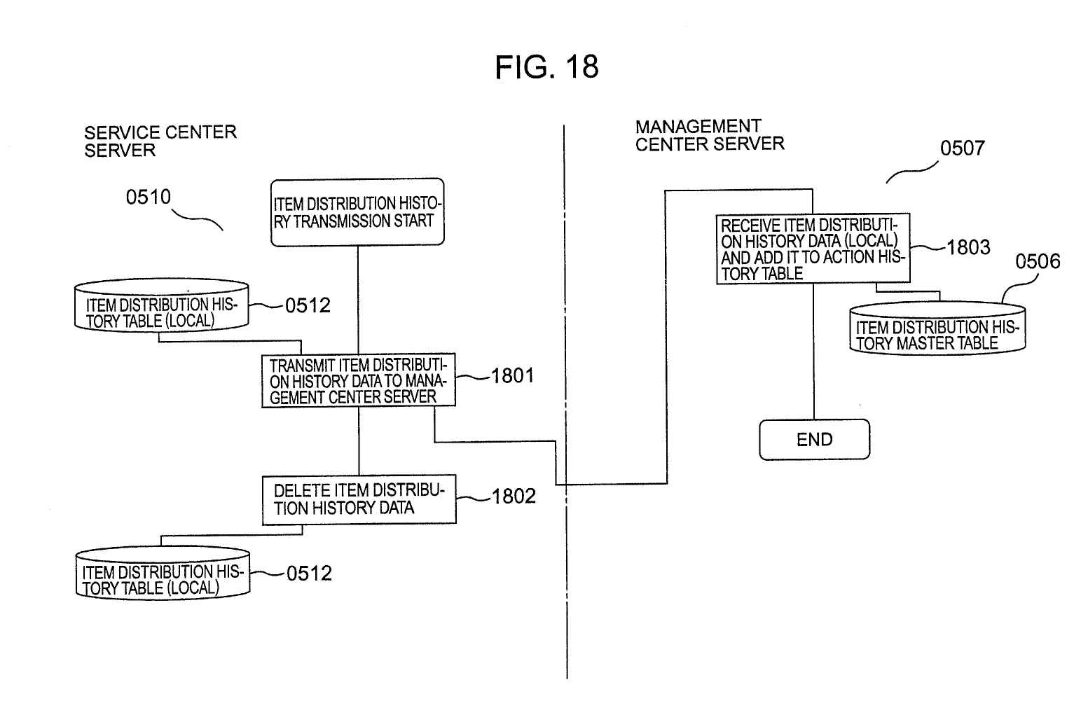

FIG. 18 shows how a service center server transmits data, accumulated in the item distribution history table (local) 0512, to the management center server. This processing is performed regularly. The service center server transmits data from the item distribution history table (local) 0512 to the management center server (steps 1801 and 1803). After successful transmission, the service center server deletes transmitted data from the item distribution history table (local) 0512 (step 1802). On the other hand, the management center adds received item distribution history data to the item distribution history master table 0506 (step 1803).

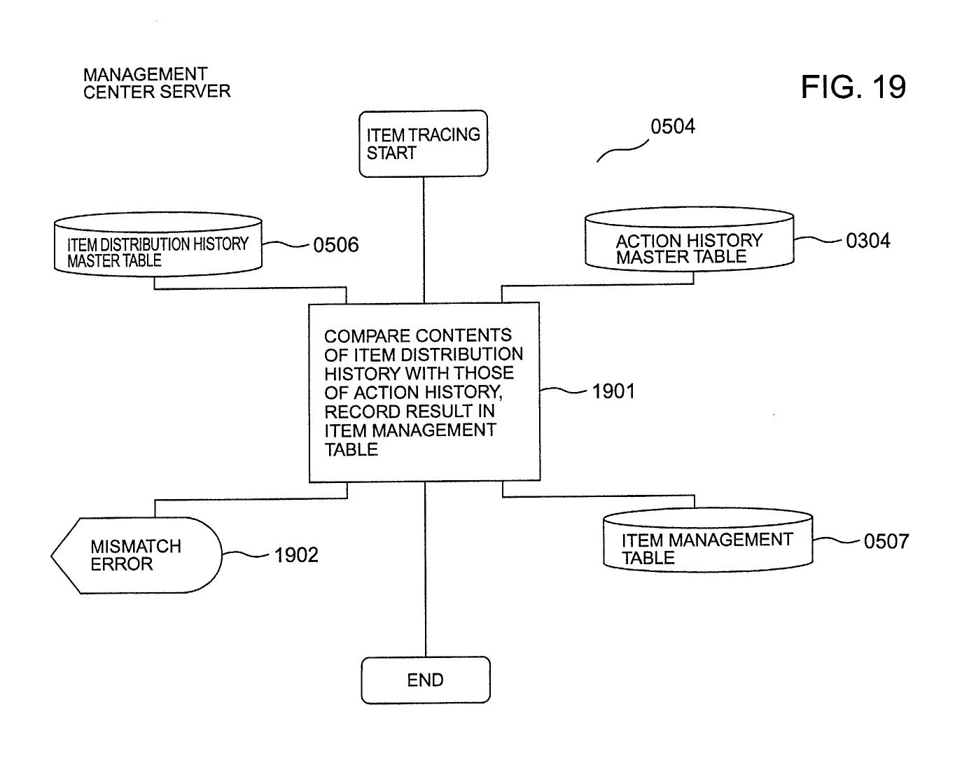

FIG. 19 shows how the management center server traces a distributed item. As shown in FIG. 13, data stored in the action history table (local) 0310 of each PDA is sent to the management center server. Therefore, the action history master table 0304 at the management center server contains item acquisition record information included in the action history table (local) 0310. The management center server compares the contents of the item distribution history master table 0506 with the contents of the action history master table 0304 to detect an item exceeding the maximum number of distributions or an illegal copy (step 1901). The management center server also records the holders of items, each with a serial number, in the item management table 0507.

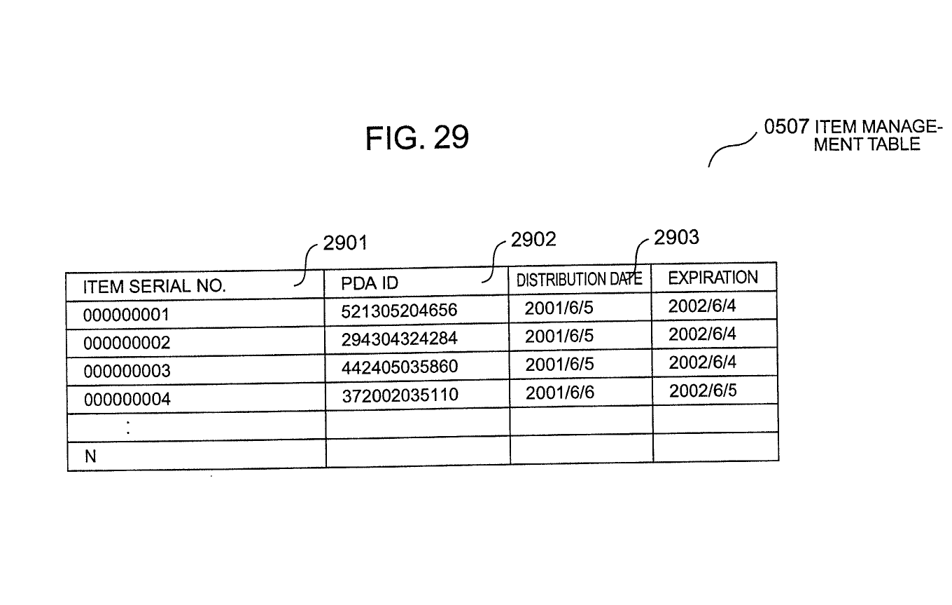

FIG. 29 shows an example of the item management table 0507. The Item Serial No. column 2901 contains an item serial number that is shown as an item serial number 2804 in FIG. 28 and as an item serial number in the Memo column 2509 in FIG. 25. The Distribution Date column 2903 is set when the access date/time in the Access Date/Time column 2801 in FIG. 28 matches the output date/time in the Output Date/Time column 2507 in FIG. 25.

Although not shown in FIG. 1, computers in stores or installations, where an item corresponding to a coupon or a premium ticket may be used, may be connected to the network. In that case, a used flag is added to the item management table 0507 in a service center server. When an item is used in a store or an installation, the used flag in the item management table is checked to prevent the item from being used more than once. When the item is used, it is also necessary for the computer in a store or an installation to ask the service center server to turn on the flag.

Alternatively, it is possible to record the use of an item in the action history table in a PDA to allow the management center server to trace the use of the item.

Many modifications and variations of the present invention are possible in the light of the above techniques. It is therefore to be understood that within the scope of the appended claims, the invention may be practiced otherwise than as specifically described.

What is claimed is:

1. An information providing system, comprising:
a client that obtains user information and sends the information to a server; and
said server that manages the user information sent from said client for each user and, based on the user information, selects information to be sent to said client.

2. The information providing system according to claim 1,
wherein said client performs a pseudo conversation with a user to obtain a user's taste as the user information.

3. The information providing system according to claim 1,
wherein the information sent from said server to said client includes advertisements.

4. The information providing system according to claim 1,
wherein said client records information on user's operation as the user information.

5. An information providing method in a network system, comprising the steps of:
preparing a plurality of agents each having its own function;
supplying one of the agents to a client in response to a user request;
collecting, by said agent, user information and sending the user information to a server;
selecting information, based on the user information, from information stored in said server; and
sending the selected information to said agent.

6. The information providing method according to claim 5,
wherein said server accumulates the received user information and uses the same user information for said plurality of agents each having its own function.

7. The information providing method according to claim 5,
wherein said agent performs a pseudo conversation with a user to collect a user's taste as the user information.

8. The information providing method according to claim 5,
wherein said server sends an instruction to said client based on the user information and
wherein said agent changes operation according to the instruction.

9. A coupon distribution method in a network system, comprising the steps of:
preparing coupons in a form of digital data;
registering said coupons and a total number of coupons to be issued with a server;
sending said coupons from said server to a client over a network; and
managing, by said server, the client to which the coupons are sent and a number of sent coupons.

10. The coupon distribution method according to claim 9,
wherein the coupons each include program code that displays a bar code on a display screen of the client in response to an instruction of a user.

11. The coupon distribution method according to claim 9,
wherein the coupons each include program code that outputs a signal from the client to an external unit in response to an instruction of a user.

12. An agent program that runs on a client in a network system, said program including code that causes a computer to execute the steps of:
displaying a human being as an animation;
performing a pseudo conversation with a user;
changing operation in response to an answer from the user;
memorizing the user's answer and sending the answer to a server; and
displaying information sent from said server.
